(19) United States
(12) Patent Application Publication
(10) Pub. No.: US 2010/0099862 A1
(43) Pub. Date: Apr. 22, 2010

(54) PROCESS FOR WASHING POLYSACCHARIDE DERIVATIVES

(76) Inventors: Matthias Sprehe, Walsrode (DE); Erik-Andreas Klohr, Walsrode (DE); Martin Kowollik, Bad Fallingbostel (DE); Werner Viereck, Walsrode (DE)

Correspondence Address: The Dow Chemical Company, Intellectual Property Section, P.O. Box 1967, Midland, MI, 48641-1967, US

(21) Appl. No.: 12/440,271

(22) PCT Filed: Apr. 18, 2007
(86) PCT No.: PCT/EP2007/003402

§ 371 Date: Dec. 8, 2009

(30) Foreign Application Priority Data
Sep. 9, 2006 (DE) 10 2006 042 438.7

(51) Int. Cl. C08B 11/20; C08B 37/00

(52) U.S. Cl. 536/56; 536/123.1

(57) ABSTRACT

The present invention relates to a novel process for removing and purifying polysaccharide derivatives, preferably cellulose ethers, from a suspension using a continuous filter device with a multitude of working zones with intermediate resuspension of the filtercake.

The present invention relates to a novel process for the removal and purification of polysaccharide derivatives, preferably cellulose ethers, from a suspension, using a continuous filter appliance having a multiplicity of working zones with intermediate resuspension of the filter cake.

Industrially important polysaccharide derivatives include cellulose ethers such as sodium carboxymethyl-celluloses, hydroxyethylcelluloses, alkylcelluloses, alkylhydroxyethylcelluloses or alkylhydroxypropyl-celluloses. Their production, properties and uses are described, inter alia, in Ullmann's Encyclopedia of Industrial Chemistry, 5th Edition (1986), volume A5, page 461-488, VCH Verlagsgesellschaft, Weinheim and Methoden der organischen Chemie [Methods in organic chemistry], 4th edition (1987), volume E20, Macromolecular substances, subvolume 3, pages 2048-2076, Georg Thieme Verlag, Stuttgart.

Cellulose ethers are swellable or colloidally soluble, they increase the viscosity of the solvent and, via their solution structure, produce a defined rheological profile. The three essential properties of cellulose ethers, the solution behavior, the resultant solution structure and the ability to bind solvents by the cellulose ethers depend on molecular characteristics such as the type, number and distribution of substituents and the molar mass distribution.

Cellulose ethers having differing degrees of substitution are produced for the most varied fields of application. The alkyl substitution is generally described in cellulose ether chemistry by the DS. The DS is the median number of substituted OH groups per anhydroglucose unit. The methyl substitution is, for example, specified as DS(M). Customarily, the hydroxy-alkyl substitution is described by the MS. The MS is the median number of moles of etherification reagent which are bound as ethers per mole of anhydroglucose unit. Etherification using the etherification reagent ethylene oxide is described, for example, as MS(HE), etherification using the etherification reagent propylene oxide as MS(HP).

The solubility in water, in the case of cellulose ethers having hydrophobic substituents such as, for example, alkyl groups, decreases with increasing temperature. A cellulose ether having hydrophobic substituents which is dissolved in cold aqueous solution can be flocculated out by heating the solution. The process is reversible, on cooling the solution the cellulose ether redissolves. The flocculation point is dependent on the substituent, on the degree of substitution and also on the electrolyte content, and can usually be varied between 20° C. and 100° C. As an example here mention may be made of methylhydroxyalkylcelluloses, in which, by varying the methyl and/or the alkyl fraction, the flocculation point may be set virtually as desired. With increasing methyl substitution, generally the flocculation point falls, and with increasing hydroxyethylation, the flocculation point is generally shifted toward higher temperatures, and with increasing electrolyte content (e.g. sodium chloride), a decrease of the flocculation point is generally caused.

By-products which occur in cellulose ether production are salts, such as sodium chloride, sodium glycolate or sodium acetate, and also a multiplicity of organic by-products, such as alcohols (methanol, ethanol inter alia), ethers (dimethyl ether inter alia), glycols (ethylene/propylene glycol inter alia), glycol ethers (ethylene/propylene glycol-monomethyl ether inter alia), which can adversely affect the service properties of the cellulose ether and must therefore be separated off. Depending on the field of use, occasionally very high requirements of the purity of cellulose ethers may be made, such that product washing represents an important process step.

In this context, the dependence of the flocculation point on substituents, on the degree of substitution and on the electrolyte content is of great importance for the industrial production of cellulose ethers, since the purification of by-products and salts by means of hot water instead of water-alcohol mixtures is made possible thereby. In addition, the degree of substitution and the electrolyte content of the cellulose ethers has an effect on the required temperature of the hot water suspension. Customarily, the temperatures of the hot water suspension and of the wash liquids are between 80° C. and 120° C.

Customarily, this purification process is carried out industrially by producing a suspension of the crude cellulose ether in hot water or organic solvent and subsequently separating the suspension into solid and liquid phase. By renewed treatment with wash liquid, steam, air or mechanical pressure, a defined purity of the end product having a corresponding moisture may be produced. Industrially, the separation and purification of the cellulose ethers is generally carried out using disk separators (EP-A 0632056), hydrocyclones (WO 95/25127), belt filters (DE-A 3044696), candle filters (EP-A 0305898), pressure-type press filters (DE-A 4112849), pressure-type rotary filters (EP-A 0326939) or centrifuges, such as solid-bowl centrifuges (EP-A 0052337) or cup-filter centrifuges (EP-A 0305899), wherein rinsing steps are possible in the separation apparatuses themselves. Customarily, a part of the suspension, wash or rinse liquid is recirculated to the production process in order to minimize product losses and reduce the water consumption.

Disadvantages of these technologies are the restricted usability for stable and effective purification of cellulose ethers. Owing to product deposition, adhesion, blockages and the necessity of long purification intervals in relation to the separation operation, stable operation, system availability and the efficiency of the separation units is critically impaired. This affects, in particular, the purification of products which have plastic or compressible modes of behavior and therefore a tendency toward gelification or compression.

In addition, owing to the temperature-dependent solubility of the products, the restricted separation efficacy of the separation units and product deposition which occurs, occasionally considerable product losses occur which can only be minimized with great expenditure and use of additional separation units (EP-A 0632056, DE-A 4134662, EP-A 0545426).

The use of the customary technologies for achieving an elevated degree of purity in the production of products for special applications such as, e.g., in the pharmaceutical and food sectors, is only possible with a very high level of operations with the use of considerable amounts of wash water.

DE 10 2004 033 328 discloses a process for solids purification using a pressure-type rotary filter in combination with resuspension, but in this context only the good wash performance is mentioned and not however advantages such as reduced solids deposition and/or product gelification as occur in the sector of polysaccharide production and processing and the avoidance of which is especially of importance here.

It has now surprisingly been found that the procedure disclosed by DE 10 2004 033 328, despite considerable mechanical and pressure/temperature stressing of the solids particles during the treatment, may be used effectively and efficiently in the purification of polysaccharide derivatives.

The invention therefore relates to a process for purifying polysaccharide derivatives which comprises at least the steps (1) feeding a water- and/or alcohol-containing suspension of a polysaccharide derivative into a continuously operating filter device having a plurality of working zones and at least partial removal of the liquid phase with formation of a filter cake, (2) ejection of the filter cake obtained in (1) from the continuously operating filter device, resuspension of the ejected filter cake by means of a water- and/or alcohol-containing wash solution in a device, (3) recirculation of the resultant suspension into a working zone of the continuously operating filter device and at least partial removal of the liquid phase with formation of a filter cake and (4) ejection of the purified polysaccharide derivative in the form of an, if appropriate, water- and/or alcohol-moist filter cake from the continuously operating filter device.

After step (2) and before step (4), in further working zones of the continuously operating filter device, further treatment steps can proceed, such as an additional purification of the filter cake by direct feed of wash liquid and/or treatment with steam, air or nitrogen to displace residual liquids and/or for drying the filter cake.

As device for the resuspension of the ejected filter cake in step (2), use is made of a mixing unit, preferably constructed as a stirred tank, loop reactor, circulation vessel or flow tube, particularly preferably constructed as a stirred tank.

As continuously operating filter device having a plurality of working zones, belt filters, disk filters, drum filters or rotary filters come into consideration. Preferably, use is made of what are termed pressure-type rotary filters as are described, for example, in WO 02/100512. A pressure-type rotary filter is a continuously operating filter in pressure-tight. construction. It consists essentially of a metallic filter drum which rotates with continuously controllable speed of rotation, an associated control head and a metallic pressure-tight housing. The annular space between filter drum and housing is sealed at the side by stuffing boxes or other sealing systems. Radially, the housing is subdivided into pressure-tight chambers by zone separation means which are pneumatically pressed onto the drum. The drum surface consists of individual filter cells which are connected to the control head via outlet tubes. A detailed description can be found in WO 02/100512 A1. The suspension which is to be filtered is fed continuously under constant inlet pressure to the separation zone of the pressure-type rotary filter, wherein a filter cake builds up in the filter cells of the rotating drum, which filter cake subsequently passes into the subsequent chambers for aftertreatment, e.g. washing and/or treatment with steam. The filter cake is taken off in an unpressurized zone of the filter either by a self-acting adjustable mechanical scraper or/and via a targeted backblow typically by means of compressed air, nitrogen or steam. An exact description of the zone separation means is found, e.g., in WO 02/100512 A1.

In a preferred embodiment, the process according to the invention comprises at least the following 8 working zones:
1st working zone: application of suspension, filter cake formation
2nd working zone: introduction of steam
3rd working zone: removal of the filter cake and resuspension with feed of wash medium in a separate stirred tank
4th working zone: recirculation of the suspension, filter cake formation
5th working zone: feed of wash medium
6th working zone: introduction of steam
7th working zone: product removal from the filter medium
8th working zone: feed of rinse water to filter medium cleaning.

It may be explicitly pointed out that the number and sequence of the working zones need not necessarily be as listed. In the process according to the invention additional working zones may be connected upstream and downstream, further working zones having different tasks can be arranged between the individual working zones and also individual working zones listed may be eliminated. In addition, alternatively or additionally to the addition of wash medium or rinsing water, steam and/or compressed air can be used.

In the washing and separation of polysaccharide derivatives by means of pressure-type rotary filters, the filter materials are constructed according to the prior art as single- or multilayer sieve or filter cloths in metal or plastic or as sintered metal. In the abovementioned process use is made of sieve cloths having a mesh width of 50 to 200 μm, particularly preferably 60 to 100 μm.

The filter loading reported as filtered dried finished product per unit filter area and unit time, in the abovementioned process, is 100 to 800 kg/m² h, particularly preferably 150 to 600 kg/m² h.

The speed of rotation of the pressure-type rotary filter used in the abovementioned process is customarily 0.3 to 2.5 rpm, preferably 0.35 to 1.8 rpm.

The residence time in the device used for the resuspension of the filter cake which is to be resuspended is, in the abovementioned process, set at 1 min to 30 min, preferably 3 min to 15 min.

The filter cake is treated according to the prior art preferably with hot water and steam. In the abovementioned process, in the above listed working zones 2 and 6, steam is used at pressures of 0.1 bar (gauge) to 6.0 bar (gauge), preferably 0.3 bar (gauge) to 4.5 bar (gauge) and particularly preferably 0.5 bar (gauge) to 3.0 bar (gauge).

The temperatures of the hot water suspension and of the wash liquids in the process according to the invention are 35° C. to 120° C., preferably 60° C. to 110° C., particularly preferably 80° C. to 99° C.

In working zone 3, in the abovementioned process, specific wash water rates, reported as amount of water per amount of filtered dried end product, of 1.5 l/kg to 35 l/kg, preferably 2 l/kg to 15 l/kg are used.

In working zone 5, in the abovementioned process, specific wash water rates, reported as amount of water per amount of filtered dried end product, of 0 l/kg to 20 l/kg, preferably of 1 l/kg to 10 l/kg, are used.

The hot water suspension used at the start having the impure crude cellulose ether resulting from the reaction has, in the abovementioned process, a solids concentration of 2 to 25% by weight, preferably 5 to 18% by weight.

In a preferred procedure, the filtrates and rinse water are recirculated to the wash zones for producing the original suspension or for product washing. Preference is given to recirculation of the wash filtrates from the zones having wash water and steam feed for production of the starting suspension and the recirculation of the rinse water for product washing in working zone 3.

The polysaccharide derivatives purified according to the abovementioned process are preferably cellulose ethers, and particularly preferably alkylhydroxyalkyl-celluloses. The flocculation points of the alkylhydroxyalkylcelluloses produced according to the abovementioned process are dependent on the substituent, on the degree of substitution and also on the electrolyte content and, for a 1% strength by weight aqueous solution with the purified finished product are between 20° C. and 100° C., particularly preferably between 35° C. and 90° C.

The sodium chloride contents which are to be achieved of the alkylhydroxyalkylcelluloses produced are based on the dry content of the product and when the process according to the invention is used are below 3.0% by weight, preferably below 0.5% by weight, particularly preferably below 0.1% by weight.

After product discharge from the continuous filter device, the purified polysaccharide derivative can be ground by conventional methods known per se if appropriate in parallel to or subsequently to drying. The resultant end product or polysaccharide derivative in the context of the present invention has, after grinding and drying, a content of residual moisture in the form of water and/or alcohols of less than 10% by weight, preferably less than 4% by weight.

### EXAMPLES

All percentages, unless marked otherwise, are to be understood as percent by weight.

### Comparative Example 1: (without External Resuspension)

Methylhydroxypropylcellulose (HPMC) having a DS (M) of 1.44, an MS (HP) of 0.26 and a flocculation point of a 1% strength by weight aqueous solution of the purified product of 70° C. was mixed with water at 90° C. to give a suspension having a solids content of 7.5%. The suspension was fed to a preheated pressure-type rotary filter having a filter area of 0.12 m², a filter cloth having 80 μm mesh width and a speed of rotation of 0.75 rpm with working step sequence hereinafter. The resultant filter loading, reported as filtered dried finished product per unit filter area and unit time was 123 kg/m² h.
1st working zone: application of suspension at 190 l/h, filter cake formation
2nd working zone: introduction of steam at 1.5 bar superatmospheric pressure
3rd working zone: wash water feed (95° C.) at 300 l/h
4th working zone: wash water feed (95° C.) at 150 l/h
5th working zone: introduction of steam at 0.6 bar superatmospheric pressure
6th working zone: product removal from the filter medium
7th working zone: feed of rinse water (95° C.) for cleaning of the filter medium

The cellulose ether could not be removed and purified by feed of steam and wash water stably using the pressure-type rotary filter over a relatively long industrially relevant period. Even after a short running time of less than 5 minutes, the filter chambers were unevenly filled, the throughputs varied greatly and the filter cloth was blocked so that the separation had to be interrupted and a cleaning interval without application of suspension was required. Also after cleaning of the filter cloth the filter cloth with application of suspension was blocked again after a short time. The resultant methylhydroxypropylcellulose, owing to the unstable procedure, had a greatly varying quality and did not have reproducibility.

The NaCl content and the moisture in the product varied greatly. The NaCl contents of individual samples of the ground and dried end product were in part markedly above 3% by weight based on the dry content of the samples, the content of residual moisture in the form of water after product washing reached values above 70%.

### Example 2: (with External Resuspension)

Methylhydroxypropylcellulose (HPMC) having a DS (M) of 1.44, an MS (HP) of 0.26 and a flocculation point of a 1% strength by weight aqueous solution of the purified product of 68° C. was mixed with water at 90° C. to give a suspension having a solids content of 8%. The suspension was fed to a preheated pressure-type rotary filter having a filter area of 0.12 m², a filter cloth of 80 μm mesh width and a speed of rotation of 0.75 rpm with working step sequence hereinafter. The resultant filter loading reported as filtered dried finished product per unit filter area and unit time was 158 kg/m² h.
1st working zone: application of suspension at 240 l/h, filter cake formation
2nd working zone: introduction of steam at 1.5 bar superatmospheric pressure
3rd working zone: removal of the filter cake and resuspension with feed of wash water (95° C.) at 300 l/h with a residence time of 5 min in a separate stirred tank
4th working zone: recirculation of suspension, filter cake formation
5th working zone: wash water feed (95° C.) at 150 l/h
6th working zone: introduction of steam at 0.6 bar superatmospheric pressure
7th working zone: product removal from the filter medium
8th working zone: feed of rinse water (95° C.) for cleaning of the filter medium

The cellulose ether could be removed and purified by steam and wash water feed stably using the pressure-type rotary filter. The filter chambers were uniformly filled and no blockage of the filter cloth occurred. The filter cloth was not coated by product residues even after a relatively long operating time of more than 45 minutes. The resultant methylhydroxypropyl-cellulose, after the product washing, has a constant content of residual moisture of 36.5% by weight in the form of water, in the ground and dried end product there is a salt content of 0.01% by weight based on the dry content of the sample.

### Example 3: (with External Resuspension)

Methylhydroxypropylcellulose (HPMC) having a DS (M) of 1.94, an MS (HP) of 0.15 and a flocculation point of a 1% strength by weight aqueous solution of the purified product of 57° C. was mixed with water at 90° C. to give a suspension having a solids content of 7%. The suspension was fed to a preheated pressure-type rotary filter having a filter area of 0.12 m², a filter cloth of 80 μm mesh width and a speed of rotation of 0.55 rpm with working step sequence hereinafter. The resultant filter loading, reported as filtered dried finished product per unit filter area and unit time, was 211 kg/m² h.
1st working zone: application of suspension at 345 l/h, filter cake formation
2nd working zone: introduction of steam at 1.3 bar superatmospheric pressure
3rd working zone: removal of the filter cake and resuspension with feed of wash water (95° C.) at 155 l/h with a residence time of 8 min in a separate stirred tank
4th working zone: recirculation of the suspension, filter cake formation
5th working zone: wash water feed (95° C.) at 75 l/h
6th working zone: introduction of steam at 0.6 bar superatmospheric pressure
7th working zone: product removal from the filter medium
8th working zone: feed of rinse water (95° C.) for cleaning of the filter medium

The cellulose ether could be removed and purified by steam and wash water feed stably using the pressure-type rotary filter. The filter chambers were evenly filled and no blockage of the filter cloth occurred. The filter cloth was not coated by product residues even after a relatively long operating time of more than 45 minutes. The resultant methylhydroxypropyl-cellulose, after the product washing, had a constant content of residual moisture of 34.1% in the form of water, in the ground and dried end product there is a salt content of 0.03% by weight based on the dry content of the sample.

### Example 4: (with External Resuspension)

Methylhydroxyethylcellulose (HEMC) having a DS (M) of 1.59, an MS (HE) of 0.32 and a flocculation point of a 1% strength by weight aqueous solution of the purified product of 75° C. was mixed with water at 90° C. to give a suspension having a solids content of 8%. The suspension was fed to a preheated pressure-type rotary filter having a filter area of 0.12 m², a filter cloth having 80 μm mesh width and a speed of rotation of 1.2 rpm with working step sequence hereinafter. The resultant filter loading, reported as filtered dried finished product per unit filter area and unit time, was 243 kg/m² h.
1st working zone: application of suspension at 370 l/h, filter cake formation
2nd working zone: introduction of steam at 1.4 bar superatmospheric pressure
3rd working zone: removal of the filter cake and resuspension with feed of wash water (95° C.) at 300 l/h with a residence time of 5.5 min in a separate stirred tank
4th working zone: recirculation of the suspension, filter cake formation
5th working zone: introduction of steam at 0.8 bar superatmospheric pressure
6th working zone: product removal from the filter medium
7th working zone: feed of rinse water (95° C.) for cleaning of the filter medium

The cellulose ether could be removed and purified by steam and wash water feed stably using the pressure-type rotary filter. The filter chambers were evenly filled and no blockage of the filter cloth, occurred. The filter cloth, even after a relatively long operating time of more than 45 minutes, was not coated by product residues. The resultant methylhydroxyethyl-cellulose, after the product washing, has a constant content of residual moisture of 46% in the form of water, in the ground and dried end product there is a salt content of 0.31% by weight based on the dry content of the sample.

1. A process for purifying polysaccharide derivatives which comprises at least the steps (1) feeding a water- and/or alcohol-containing suspension of a polysaccharide derivative into a continuously operating filter device having a plurality of working zones and at least partial removal of the liquid phase with formation of a filter cake, (2) ejection of the filter cake obtained in (1) from the continuously operating filter device, resuspension of the ejected filter cake by means of a water- and/or alcohol-containing wash solution in a device, (3) recirculation of the resultant suspension into a working zone of the continuously operating filter device and at least partial removal of the liquid phase with formation of a filter cake and (4) ejection of the purified polysaccharide derivative in the form of an, if appropriate, water- and/or alcohol-moist filter cake from the continuously operating filter device.

2. The process as claimed in claim 1, wherein the device for the resuspension in step (2) is a stirred tank.

3. The process as claimed in claim 1, wherein the continuously operating filter device having a plurality of working zones is a belt filter, disk filter, drum filter or rotary filter.

4. The process as claimed in claim 3, wherein the filter device is a pressure-type rotary filter.

5. The process as claimed in claim 1, wherein the process comprises at least the following working zones:
application of suspension, filter cake formation
introduction of steam
removal of the filter cake and resuspension with feed of wash medium in a separate stirred tank
recirculation of the suspension, filter cake formation
feed of wash medium
introduction of steam
product removal from the filter medium
feed of rinse water to filter medium cleaning.

6. The process as claimed claim 1, wherein a filter cloth having a mesh width of 60 to 100 μm is used.

7. The process as claimed in claim 1, wherein the filter loading, reported as filtered dried finished product per unit filter area and unit time is 150 to 600 kg/m² h.

8. The process as claimed in claim 1, wherein the residence time in the device used for resuspension of the filter cake which is to be resuspended is 3 to 15 min.

9. The process as claimed in claim 1, wherein the polysaccharide derivatives are alkylhydroxyalkylcelluloses which, as purified substance, have flocculation points of 35 and 90° C. measured on a 1% strength by weight aqueous solution.

10. The process as claimed in claim 1, wherein the sodium chloride contents in the ground and dried end product are less than 0.5% by weight, based on the dry content of the sample.

11. The process as claimed in claim 1, wherein the purified polysaccharide derivative obtained in such a way is subsequently ground, if appropriate in parallel to or subsequently to a drying.
